(19) United States
(12) Patent Application Publication
(10) Pub. No.: US 2023/0174716 A1
(43) Pub. Date: Jun. 8, 2023

(54) POLYMER COMPOSITIONS HAVING IMPROVED MECHANICAL PROPERTIES AT ELEVATED TEMPERATURES AND CORRESPONDING ARTICLES

(71) Applicant: SOLVAY SPECIALTY POLYMERS USA, LLC, Alpharetta, GA (US)

(72) Inventors: David McIlroy, Johns Creek, GA (US); Matthew R. Vincent, Buford, GA (US); Lee Carvell, Cumming, GA (US); Linda M. Norfolk, Cumming, GA (US)

(73) Assignee: SOLVAY SPECIALTY POLYMERS USA, LLC, Alpharetta, GA (US)

(21) Appl. No.: 17/923,791

(22) PCT Filed: May 5, 2021
(86) PCT No.: PCT/EP2021/061907

§ 371 Date: Nov. 7, 2022

Related U.S. Application Data
(60) Provisional application No. 63/021,109, filed on May 7, 2020.

(30) Foreign Application Priority Data
Jul. 14, 2020 (EP) 20185589.7

(51) Int. Cl. C08G 69/26; C08G 69/28; C08K 7/06; C08K 7/14

(52) U.S. Cl. CPC C08G 69/265; C08G 69/28; C08K 7/06; C08K 7/14

(57) ABSTRACT

Described herein are polymer compositions (PC) including a polyamide and carbon fiber. As explained in detail below, the polyamide (PA) is a semi-aromatic polyamide derived from the polycondensation of an aliphatic diamine, terephthalic acid, and a bis(aminoalkyl)cyclohexane or a cyclohexanedicarboxylic acid. It was surprisingly discovered that incorporation of the cycloaliphatic diamine bis(aminoalkyl)cyclohexane or the specific combination of the cycloaliphatic diamine bis(aminoalkyl)cyclohexane and the cycloaliphatic dicarboxylic acid cyclohexanedicarboxylic acid into the polyamide provided for carbon fiber filled polymer compositions (PC) having significantly improved mechanical properties (e.g. tensile modulus and strength) at elevated temperatures, as well as significantly improved retention of mechanical properties after heat aging, relative to analogous polyamides free of the bis(aminoalkyl)cyclohexane and the cyclohexanedicarboxylic acid. Due at least in part to the improved elevated temperature mechanical properties, as well as their heat aging retention, the polyamides (PA) can be desirably incorporated into structural articles that, during use, are exposed to elevated temperatures.

### CROSS REFERENCE TO RELATED APPLICATIONS

The present application claims priority to US provisional patent application no. Nr 63/021,109, filed on 7 May 2020, and to European patent application no. 20185589.7, filed on 14 Jul. 2020, the whole content of each of these being incorporated herein by reference for all purposes.

### FIELD OF THE INVENTION

The invention relates to polymer compositions including a polyamide and carbon fiber and having excellent mechanical properties at elevated temperature and excellent retention of mechanical properties after heat aging. The invention also relates to such polymer compositions including a blend of carbon fibers and glass fibers. The invention still further relates to articles incorporating the polymer compositions.

### BACKGROUND OF THE INVENTION

Traditionally, semi-aromatic polyamides are used for the manufacture automotive components because of their relatively high mechanical properties (e.g. tensile modulus and tensile strength) and chemical resistance. However, in application settings in which the automotive component is exposed to elevated temperatures (e.g. 125° C. or higher), the semi-aromatic polyamides have relatively high flexibility (relatively low tensile modulus) and relatively low strength and, therefore, such materials are not optimal for structural automotive components in such application settings. Furthermore, the mechanical properties of such polyamides are compromised to undesirable levels after prolonged exposure to elevated temperatures. In general, then, traditional semi-aromatic polyamides have limited application in structural components that are exposed to elevated temperatures in their intended use environments.

### SUMMARY OF INVENTION

In a first aspect, the invention is direct to polymer composition (PC) comprising: a polyamide (PA) and a carbon fiber. The polyamide (PA) is derived from the polycondensation of monomers in a reaction mixture comprising: a diamine component (A) comprising: 20 mol % to 95 mol % of a C₄ to C₁₂ aliphatic diamine and 5 mol % to 80 mol % of bis(aminoalkyl)cyclohexane, wherein mol % is relative to the total moles of each diamine in the diamine component; and a dicarboxylic acid component (B) comprising: 30 mol % to 100 mol % of terephthalic acid and 0 mol % to 70 mol % of a cyclohexanedicarboxylic acid, wherein mol % is relative to the total moles of each dicarboxylic acid in the dicarboxylic acid component. In some embodiments, the bis(aminoalkyl)cyclohexane is 1,3-bis(aminomethyl)cyclohexane or 1,4-bis(aminomethyl)cyclohexane. In some embodiments, the dicarboxylic acid component (B) comprises 1 mol % to 70 mol % of cyclohexanedicarboxylic acid, preferably 1,4-cyclohexanedicarboxylic acid, relative to the total moles of each dicarboxylic acid in the dicarboxylic acid component. In some embodiments, the bis(aminoalkyl)cyclohexane is 1,3-bis(aminomethyl)cyclohexane and the cyclohexane dicarboxylic acid is 1,4-cyclohexanedicarboxylic acid. In some embodiments, the polymer composition (PC) comprises glass fiber. In some such embodiments, the weight ratio of the carbon fiber to the glass fiber is from 0.05 to 4, preferably 0.15 to 4.

In some embodiments, the polymer composition (PC) comprises a tensile modulus at 125° C. of at least 20 GPa and a tensile modulus at 150° C. of at least 12 GPa. In some embodiments, the polymer composition (PC) comprises a tensile strength at 125° C. of at least 140 MPa and a tensile modulus at 150° C. of at least 100 MPa. In some embodiments, the polymer composition (PC) comprises a tensile strength retention of at least 80%. In some embodiments, the polymer composition (PC) comprises a tensile strength after heat aging of at least 80%, wherein heat aging comprises heating the polymer composition (PC) at 200° C. for 500 hours.

In another aspect, the invention is directed to an article comprising the polymer composition, wherein the articles is an automotive component or an aerospace components.

### DETAILED DESCRIPTION OF THE INVENTION

Described herein are polymer compositions (PC) including a polyamide and carbon fiber. As explained in detail below, the polyamide (PA) is a semi-aromatic polyamide derived from the polycondensation of an aliphatic diamine, terephthalic acid, and a bis(aminoalkyl)cyclohexane or a cyclohexanedicarboxylic acid. It was surprisingly discovered that incorporation of the cycloaliphatic diamine bis(aminoalkyl)cyclohexane or the specific combination of the cycloaliphatic diamine bis(aminoalkyl)cyclohexane and the cycloaliphatic dicarboxylic acid cyclohexanedicarboxylic acid into the polyamide provided for carbon fiber filled polymer compositions (PC) having significantly improved mechanical properties (e.g. tensile modulus and strength) at elevated temperatures, as well as significantly improved retention of mechanical properties after heat aging, relative to analogous polyamides free of the bis(aminoalkyl)cyclohexane and the cyclohexanedicarboxylic acid. Due at least in part to the improved elevated temperature mechanical properties, as well as their heat aging retention, the polyamides (PA) can be desirably incorporated into structural articles that, during use, are exposed to elevated temperatures.

In the present application, any description, even though described in relation to a specific embodiment, is applicable to and interchangeable with other embodiments of the present disclosure. Where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and any recitation herein of numerical ranges by endpoints includes all numbers subsumed within the recited ranges as well as the endpoints of the range and equivalents.

Unless specifically limited otherwise, the term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of a cycloaromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

It was surprisingly discovered that incorporation of the cycloaliphatic diamine bis(aminoalkyl)cyclohexane or the cycloaliphatic dicarboxylic acid cyclohexanedicarboxylic acid into the polyamide provided for polymer compositions (PC) having significantly improved mechanical properties (e.g. tensile modulus and strength) at elevated temperatures, as well as significantly improved retention of mechanical properties after heat aging, relative to analogous polyamides derived from the aliphatic diamine and terephthalic acid, but free of the bis(aminoalkyl)cyclohexane and the cyclohexanedicarboxylic acid. In some embodiments, the polymer composition (PC) has a tensile modulus at 125° C. of at least 15 GPa, at least 17 GPa, at least 20 GPa or at least 25 GPa. In some embodiments, the polymer composition (PC) has a tensile modulus at 125° C. of no more than 35 GPa, no more than 30 GPa, no more than 25 GPa or no more than 23 GPa. In some embodiments, the polymer composition (PC) has a tensile modulus at 125° C. of from 20 GPa to 35 GPa, from 25 GPa to 35 GPa, from 25 GPa to 30 GPa, from 15 GPa to 30 GPa, from 17 GPa to 27 GPA, from 20 GPa to 25 GPa or from 20 GPa to 23 GPa. In some embodiments, the polymer composition (PC) has a tensile modulus at 140° C. of at least 10 GPa, at least 13 GPa at least 15 GPa or at least 20 GPa. In some embodiments, the polymer composition (PC) has a tensile modulus at 140° C. of no more than 30 GPa, no more than 25 GPa, no more than 20 GPa or no more than 18 GPa. In some embodiments, the polymer composition (PC) has a tensile modulus at 140° C. of from 15 GPa to 30 GPa, from 20 GPa to 30 GPa, from 15 GPa to 25 GPa, from 20 GPa to 25 GPa, from 10 GPa to 25 GPa, from 13 GPa to 20 GPa, from 15 GPa to 20 GPa or from 15 GPa to 18 GPa. In some embodiments, the polymer composition (PC) has a tensile modulus at 150° C. of at least 8 GPa, at least 10 GPa, at least 12 GPa or at least 16 GPa. In some embodiments, the polymer composition (PC) has a tensile modulus at 150° C. of no more than 25 GPa, no more than 20 GPa, no more than 18 GPa or no more than 15 GPa. In some embodiments, the polymer composition (PC) has a tensile modulus at 150° C. of from 12 GPa to 25 GPa, from 16 GPa to 25 GPa, from 12 GPa to 20 GPa, from 16 GPa to 20 GPa, from 8 GPa to 20 GPa, from 10 GPa to 18 GPa, from 12 GPa to 18 GPa or from 12 GPa to 15 GPa. Tensile modulus can be measured as described in the Examples section.

In some embodiments, the polymer composition (PC) has a tensile strength at 125° C. of at least 120 MPa, at least 130 MPa, at least 140 MPa, at least 160 MPa, at least 170 MPa or at least 180 MPa. In some embodiments, the polymer composition (PC) has a tensile strength at 125° C. of no more than 195 MPa, no more than 190 MPa, no more than 185 MPa, no more than 170 MPa, no more than 160 MPa or no more than 150 MPa. In some embodiments, the polymer composition (PC) has a tensile strength at 125° C. of from 160 MPa to 195 MPa, from 170 MPa to 195 MPa, from 180 MPa to 195 MPa, from 180 MPa to 190 MPa, from 180 MPa to 185 MPa, from 120 MPa to 170 MPa, from 130 MPa to 160 MPa or from 140 MPa to 150 MPa. In some embodiments, the polymer composition (PC) has a tensile strength at 140° C. of at least 110 MPa, at least 115 MPa, at least 120 MPa, at least 140 MPa, at least 150 MPa or at least 160 MPa. In some embodiments, the polymer composition (PC) has a tensile strength at 140° C. of no more than 180 MPa, no more than 170 MPa, no more than 165 MPa, no more than 140 MPa, no more than 135 MPa or no more than 130 MPa. In some embodiments, the polymer composition (PC) has a tensile strength at 140° C. of from 140 MPa to 180 MPa, from 150 MPa to 180 MPa, from 160 MPa to 180 MPa, from 160 MPa to 170 MPa, from 160 MPa to 165 MPa, from 110 Mpa to 140 MPa, from 115 MPa from 135 MPa or from 120 MPa to 130 MPa. In some embodiments, the polymer composition (PC) has a tensile strength at 150° C. of at least 90 MPa, at least 95 MPa, at least 100 MPa, at least 120 MPa, at least 125 MPa or at least 130 MPa. In some embodiments, the polymer composition (PC) has a tensile strength at 150° C. of no more than 150 MPa, no more than 140 MPa, no more than 135 MPa, no more than 115 MPa, no more than 110 MPa or no more than 105 MPa. In some embodiments, the polymer composition (PC) has a tensile strength at 150° C. of from 120 MPa to 150 MPa, from 125 MPa to 150 MPa, from 130 MPa to 150 MPa, from 130 MPa to 140 MPa, from 130 MPa to 135 MPa. Tensile strength can be measured as described in the Examples section.

As noted above, the polymer compositions also have improved tensile strength retention. Tensile strength retention is given by the following formula: 100*TS₁/TS₀, where TS₁ is the tensile strength after heat aging, TS₀ is tensile strength prior to heat aging and heat aging consists of heating the polymer composition (PC) at a temperature of 200° C. for 500 hours. In some embodiments, the polymer composition (PC) has a tensile strength after heat aging of at least 215 MPa, at least 220 MPa or at least 225 MPa. In some embodiments, the polymer composition (PC) has a tensile strength after heat aging of no more than 240 MPa, no more than 235 MPa or no more than 230 MPa. In some embodiments, the polymer composition (PC) has a tensile strength after heat aging of from 215 MPa to 240 MPa, from 220 MPa to 240 MPa, from 225 MPa to 240 MPa, from 225 MPa to 235 MPa, from 225 MPa to 230 MPa. In some embodiments, the polymer composition (PC) has a tensile strength retention after heat aging of at least 70%, at least 75% or at least 80%. In some embodiments, the polymer composition (PC) has a tensile strength retention of no more than 95%, no more than 90% or no more than 85%. In some embodiments, the polymer composition (PC) has a tensile strength retention after heat aging of from 70% to 95% from 75% to 95%, from 80% to 95%, from 80% to 90%, from 80% to 85%.

### The Polyamide (PA)

The polymer composition (PC) includes a polyamide (PA). The polyamide (PA) is derived from the polycondensation of monomers in a reaction mixture comprising: (1) a diamine component (A) comprising 20 mol % to 95 mol % of a C₄ to C₁₂ aliphatic diamine and 5 mol % to 80 mol % of a bis(aminoalkyl)cyclohexane, where mol % is relative to the total moles of each diamine monomer in the diamine component; and (2) a dicarboxylic acid component (B) comprising: 30 mol % to 100 mol % of terephthalic acid and 0 mol % to 70 mol %, preferably 1 mol % to 70 mol %, of a cyclohexane dicarboxylic acid, wherein mol % is relative to the total moles of each dicarboxylic acid monomer in the dicarboxylic acid component. It was surprisingly discovered that the incorporation of the bis(aminoalkyl)cyclohexane, or the specific combination of the bis(aminoalkyl)cyclohexane and the cyclohexanedicarboxylic acid, into semi-aromatic polyamides provides for carbon fiber filled polymer compositions (PC) having mechanical properties at elevated temperatures. The polyamides described herein have a glass transition temperature (“Tg”) of at least 145° C., melting temperature (“Tm”) of at least 295° C., and a heat of fusion (“ΔH_{f}”) of at least 30 J/g.

### The Diamine Component (A)

The diamine component (A) includes all diamines in the reaction mixture, including 20 mol % to 95 mol % C₄ to C₁₂ aliphatic diamine and 5 mol % to 80 mol % of a bis(aminoalkyl)cyclohexane. When referring to the concentration of monomers in the diamine component (A), it will be understood that the concentration is relative to the total number of moles of all diamines in the diamine component (A), unless explicitly noted otherwise.

In some embodiments, the C₄ to C₁₂ aliphatic diamine is represented by the following formula:

H₂N—R₁—NH₂, (1)

where R₁ is a C₄ to C₁₂ alkyl group, preferably a C₆ to C₁₀ alkyl group. In some embodiments, the C₄ to C₁₂ aliphatic diamine is selected from the group consisting of 1,4-diaminobutane (putrescine), 1,5-diaminopentane (cadaverine), 2-methyl-1,5-diaminopentane, hexamethylenediamine (or 1,6-diaminohexane), 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, and 1,12-diaminododecane. Preferably, the C₄ to C₁₂ aliphatic diamine is selected from the group consisting of 1,6-diaminohexane, 3-methylhexamethylenediamine, 2,2,4-trimethyl-hexamethylenediamine, 2,4,4-trimethyl-hexamethylenediamine, 1,9-diaminononane, 2-methyl-1,8-diaminooctane, 5-methyl-1,9-diaminononane, and 1,10-diaminodecane. Preferably, the C₄ to C₁₂ aliphatic diamine is a C₅ to C₁₀ aliphatic diamine or a C₅ to C₉ aliphatic diamine. Most preferably, the C₄ to C₁₂ aliphatic diamine is 1,6-diaminohexane.

In some embodiments, concentration of the C₆ to C₁₂ aliphatic diamine is from 25 mol % to 95 mol %, from 30 mol % to 95 mol %, from 35 mol % to 95 mol %, from 40 mol % to 95 mol %, from 45 mol % to 95 mol %, or from 50 mol % to 95 mol %. In some embodiments, concentration of the C₆ to C₁₂ diamine is from 20 mol % to 90 mol %, from 25 mol % to 90 mol %, from 30 mol % to 90 mol %, from 35 mol % to 90 mol %, from 40 mol % to 90 mol %, from 45 mol % to 90 mol %, or from 50 mol % to 90 mol %.

The bis(aminoalkyl)cyclohexane is represented by the following formula:

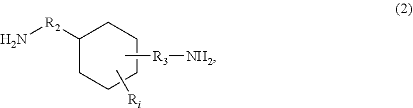

where R₂ and R₃ are independently selected C₁ to C₁₀ alkyls; Rᵢ, at each location, is selected from the group consisting of an alkyl, an aryl, an alkali or alkaline earth metal sulfonate, an alkyl sulfonate, and a quaternary ammonium; and i is an integer from 0 to 10. The —R₃—NH₂ groups are relatively positioned in the meta position (1,3-) or the para position (1,4-). Preferably, i is 0 and R₂ and R₃ are both —CH₂—. Most preferably, the bis(aminoalkyl)cyclohexane is selected from 1,3-bis(aminomethyl)cyclohexane (“1,3-BAC”) and 1,4-bis(aminomethyl)cyclohexane (“1,4-BAC”). Of course, the bis(aminoalkyl)cyclohexane can be in a cis or trans conformation. Accordingly, the diamine component (A) can include only the cis-bis(aminoalkyl)cyclohexane, only trans-bis(aminoalkyl)cyclohexane or a mixture of cis- and trans-bis(aminoalkyl)cyclohexane.

In some embodiments, the concentration of the bis(aminoalkyl)cyclohexane is from 5 mol % to 75 mol %, from 5 mol % to 70 mol %, from 5 mol % to 65 mol %, from 5 mol % to 60 mol %, from 5 mol % to 55 mol %, or from 5 mol % to 50 mol %. In some embodiments, the concentration of the bis(aminoalkyl)cyclohexane is from 10 mol % to 75 mol %, from 10 mol % to 70 mol %, from 10 mol % to 65 mol %, from 10 mol % to 60 mol %, from 10 mol % to 55 mol %, or from 10 mol % to 50 mol %, or from 20 mol % to 40 mol %.

As noted above, in some embodiments, the diamine component (A) includes one or more additional diamines. The additional diamines are distinct from the C₄ to C₁₂ aliphatic diamine and distinct from the bis(aminoalkyl)cyclohexane. In some embodiments, one, some, or all of the additional diamines are represented by Formula (1), each distinct from each other and distinct from the C₄ to C₁₂ aliphatic diamine. In some embodiments, the each additional diamine is selected from the group consisting of 1,2 diaminoethane, 1,2-diaminopropane, propylene-1,3-diamine, 1,3 diaminobutane, 1,4-diaminobutane, 1,5-diaminopentane, 2-methyl-1,5-diaminopentane, 1,6-diaminohexane, 3-methylhexamethylenediamine, 2,5 dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7 tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12-diaminododecane, 1,13-diaminotridecane, 2,5-bis(aminomethyl)tetrahydrofuran and N,N-Bis(3-aminopropyl)methylamine. Included in this category are also cycloaliphatic diamine such as isophorone diamine, 1,3-diaminocyclohexane, 1,4-diaminocyclohexane, bis-p-aminocyclohexylmethane. In some embodiments, the diamine component is free of cycloaliphatic diamines others than the bis(aminoalkyl)cyclohexane. As used herein, free of a monomer (e.g. bis(aminoalkyl)cyclohexane) means that the concentration of the monomer in the corresponding component (e.g. the diamine component (A)) is less than 1 mol %, preferably less than 0.5 mol. %, more preferably less than 0.1 mol %, even more preferably less than 0.05 mol %, most preferably less than 0.01 mol %.

### The Dicarboxylic Acid Component (B)

The dicarboxylic acid component (B) includes all dicarboxylic acids in the reaction mixture, including 30 mol % to 100 mol % of terephthalic acid and 0 mol % to 70 mol %, preferably from 1 mol % to 70 mol %, of a cyclohexanedicarboxylic acid. When referring to the concentration of monomers in the dicarboxylic acid component (B), it will be understood that the concentration is relative to number of moles of all dicarboxylic acids in the dicarboxylic acid component (A), unless explicitly noted otherwise.

In some embodiments, the concentration of the terephthalic acid is from 35 mol % to 100 mol %, from 35 mol % to 100 mol %, from 40 mol % to 100 mol %, from 45 mol % to 100 mol %, or from 50 mol % to 100 mol %. In some embodiments, the concentration of the terephthalic acid is from 30 mol % to 99 mol %, from 35 mol % to 99 mol %, from 40 mol % to 99 mol %, from 45 mol % to 99 mol % or from 50 mol % to 99 mol %. In some embodiments, the concentration of the terephthalic acid is from 30 mol % to 95 mol %, from 35 mol % to 97 mol %, from 40 mol % to 97 mol %, from 45 mol % to 97 mol % or from 50 mol % to 97 mol %.

The cyclohexanedicarboxylic acid is represented by the following formula:

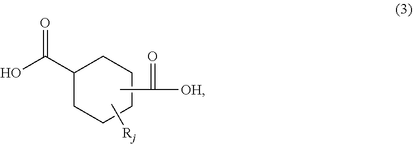

where Rⱼ is selected from the group consisting of an alkyl, an aryl, an alkali or alkaline earth metal sulfonate, an alkyl sulfonate, and a quaternary ammonium; and j is an integer from 0 to 10. The explicit —COOH groups are relatively positioned in the meta position (1,3-) or the para position (1,4-), preferably the para position. Preferably, the cyclohexanedicarboxylic acid is 1,4-cyclohexanedicarboxylic acid (“CHDA”) (j is 0). Of course, the cyclohexanedicarboxylic acid can be in a cis or trans conformation. Accordingly, the dicarboxylic acid component (B) can include only the cis-cyclohexanedicarboxylic acid, only trans-cyclohexanedicarboxylic acid or a mixture of cis- and trans-cyclohexanedicarboxylic acid.

In some embodiments, the concentration of the cyclohexanedicarboxylic acid is from 1 mol % to 70 mol %, from 1 mol % to 65 mol %, from 1 mol %, to 60 mol %, from 1 mol % to 55 mol %, or from 1 mol % to 50 mol. %.

As noted above, in some embodiments, the dicarboxylic acid component (B) includes one or more additional dicarboxylic acids. Each additional dicarboxylic acid is distinct from each other and distinct from the terephthalic acid and the cyclohexanedicarboxylic acid. In some embodiments, one, some, or all of the additional dicarboxylic acids are represented by Formula (3), each distinct from each other and distinct from the cyclohexanedicarboxylic acid.

In some embodiments, the one or more additional dicarboxylic acids are independently selected from the group consisting of C₄ to C₁₂ aliphatic dicarboxylic acids, aromatic dicarboxylic acids, and cycloaliphatic dicarboxylic acids. Examples of desirable C₄ to C₁₀ aliphatic dicarboxylic acids include, but are not limited to, succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅COOH], suberic acid [HOOC—(CH₂)₆—COOH], azelaic acid [HOOC—(CH₂)₇—COOH], sebacic acid [HOOC—(CH₂)₈—COOH], 1,12-dodecanedioic acid [HOOC—(CH₂)₁₀—COOH].

Examples of desirable aromatic dicarboxylic acids include, but are not limited to, phthalic acids, including isophthalic acid (IA), naphthalenedicarboxylic acids (e.g. naphthalene-2,6-dicarboxylic acid), 4,4′ bibenzoic acid, 2,5-pyridinedicarboxylic acid, 2,4-pyridinedicarboxylic acid, 3,5-pyridinedicarboxylic acid, 2,2-bis(4-carboxyphenyl)propane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, 2,2-bis(3-carboxyphenyl)hexafluoropropane, 2,2-bis(3-carboxyphenyl)ketone, bis(3-carboxyphenoxy)benzene.

Examples of desirably cycloaliphatic dicarboxylic acids include, but are not limited to, cyclopropane-1,2-dicarboxylic acid, 1-methylcyclopropane-1,2-dicarboxylic acid, cyclobutane-1,2-dicarboxylic acid, tetrahydrofuran-2,5-dicarboxylic acid, 1,3-adamantanedicarboxylic acid.

In some embodiments in which the polyamide (PA) includes one or more additional dicarboxylic acids, the total concentration of the one or more additional dicarboxylic acids is no more than 20 mol. %.

### Recurring Units of the Polyamide (PA)

The polyamide (PA) formed from the polycondensation of the monomers in the diamine component and dicarboxylic acid component, as described above, includes recurring units R_{PA1} and R_{PA2}, represented by the following formulae, respectively:

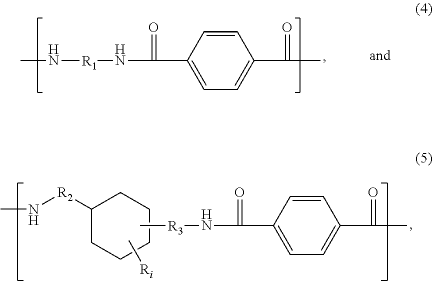

and additionally, when the cyclohexanedicarboxylic acid is present in the dicarboxylic acid component (B), recurring units R_{PA3} and R_{PA4} represented by the following formulae, respectively:

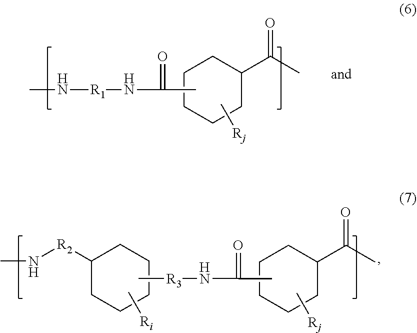

where R₁ to R₃, Rᵢ, Rⱼ, i and j are as defined above. The person of ordinary skill in the art will recognize that recurring unit R_{PA1} is formed from the polycondensation of the C₄ to C₁₂ aliphatic diamine with the terephthalic acid, recurring unit R_{PA3} is formed from the polycondensation of the C₄ to C₁₂ aliphatic diamine with the cyclohexane dicarboxylic acid, recurring unit R_{PA2} is formed from the polycondensation of the bis(aminoalkyl)cyclohexane with the terephthalic acid, and recurring unit R_{PA4} is formed from the polycondensation of the bis(aminoalkyl)cyclohexane with the cyclohexanedicarboxylic acid. In some embodiments, R₁ is —(CH₂)—ₘ, where m is from 5 to 10, preferably from 5 to 9, most preferably 6. Additionally or alternatively, in some embodiments R₂ and R₃ are both —CH₂—, and i and j are both zero. In some embodiments, the bis(aminoalkyl)cyclohexane is 1,3-bis(aminomethyl)cyclohexane and the cyclohexanedicarboxylic acid is 1,4-cyclohexane dicarboxylic acid.

In some embodiments, the total concentration of recurring units R_{PA1} and R_{PA2} is at least 50 mol %, at least 60 mol %, at least 70 mol %, at least 80 mol %, at least 90 mol %, at least 95 mol %, at least 97 mol %, at least 98 mol %, at least 99 mol % or at least 99.5 mol %. In some embodiments in which the optional cyclohexanedicarboxylic acid is present in the dicarboxylic acid component (B), the total concentration of recurring units R_{PA1} to R_{PA4} is at least 50 mol %, at least 60 mol %, at least 70 mol %, at least 80 mol %, at least 90 mol %, at least 95 mol %, at least 97 mol %, at least 98 mol %, at least 99 mol % or at least 99.5 mol %. When referring to mol % of a recurring unit, it will be understood that the concentration is relative to the total number of recurring units in the indicated polymer, unless explicitly noted otherwise.

The polyamides (PA) are semi-crystalline polyamides. As used herein, a semi-crystalline polyamide is a polyamide that has a heat of fusion (“ΔH_{f}”) of at least 5 Joules per gram (“J/g”). In some embodiments, the polyamides (PA) described herein have a ΔH_{f} of at least 30 J/g, or at least 35 J/g. Additionally or alternatively, in some embodiments the polyamide (PA) has a ΔH_{f} of no more than 60 J/g or no more than 55 J/g. In some embodiments, the polyamide (PA) has a ΔH_{f} of from 30 J/g to 60 J/g or from 35 J/g to 60 J/g, from 30 J/g to 55 J/g, or from 35 J/g to 55 J/g. ΔH_{f} can be measured according to ASTM D3418 using a heating rate of 20° C./minute.

The polyamide (PA) has a Tg of at least 145° C., preferably at least 150° C. In some embodiments, the polyamide (PA) has a Tg of no more than 190° C., no more than 180° C., or no more than 170° C. In some embodiments, the polyamide (PA) has a Tg of from 145° C. to 190° C., from 145° C. to 180° C., from 145° C. to 170° C., from 150° C. to 190° C., from 150° C. to 180° C., or from 150° C. to 170° C. Tg can be measured according to ASTM D3418.

The polyamide (PA) has a Tm of at least 295° C., preferably at least 300° C. In some embodiments the polyamide (PA) has a Tm of no more than 360° C., no more than 350° C., or no more than 340° C. In some embodiments, the polyamide (PA) has a Tm of from 295° C. to 360° C., from 295° C. to 350° C., from 295° C. to 340° C., 300° C. to 360° C., from 300° C. to 350° C. or from 300° C. to 340° C. Tm can be measured according to ASTM D3418. In some embodiments, the polyamide (PA) has a number average molecular weight (“Mn”) ranging from 1,000 g/mol to 40,000 g/mol, for example from 2,000 g/mol to 35,000 g/mol, from 4,000 to 30,000 g/mol, or from 5,000 g/mol to 20,000 g/mol. The number average molecular weight Mn can be determined by gel permeation chromatography (GPC) using ASTM D5296 with polystyrene standards.

The polyamide (PA) described herein can be prepared by any conventional method adapted to the synthesis of polyamides and polyphthalamides. Preferentially, the polyamide (PA) is prepared by reacting (by heating) the monomers in presence of less than 60 wt. % of water, preferentially less than 50 wt. %, up to a temperature of at least Tm+10° C., Tm being the melting temperature of the polyamide (PA), where wt. % is relative to the total weight of the reaction mixture.

The polyamide (PA) described herein can for example be prepared by thermal polycondensation (also referred to as polycondensation or condensation) of aqueous solution of monomers and comonomers. In one embodiment, the polyamide (PA) is formed by reacting, in the reaction mixture, at least the C₄ to C₁₂ aliphatic diamine, the bis(aminoalkyl)cyclohexane, the terephthalic acid, and, if present in the dicarboxylic acid component (B), the cyclohexanedicarboxylic acid. In some embodiments, the total number of moles of diamines in the reaction mixture is substantially equimolar to the total number of moles of dicarboxylic acids in the reaction mixture. As used herein, substantial equimolar denotes a value that is ±15% of the indicated number of moles. For example, in the context of the diamine and dicarboxylic acid concentrations in the reaction mixture, total number of moles of diamines in the reaction mixture is ±15% of the total number of moles of dicarboxylic acids in the reaction mixture. The polyamides (PA) may contain a chain limiter, which is a monofunctional molecule capable of reacting with the amine or carboxylic acid moiety, and is used to control the molecular weight of the polyamide (PA). For example, the chain limiter can be acetic acid, propionic acid, benzoic acid and/or benzylamine. A catalyst can also be used. Examples of catalyst are phosphorous acid, ortho-phosphoric acid, meta-phosphoric acid, alkali-metal hypophosphite such as sodium hypophosphite and phenylphosphinic acid. A stabilizer, such as a phosphite, may also be used.

### The Polymer Composition (PC)

The polymer composition (PC) includes the polyamide (PA), carbon fiber and one or more optional components selected from the group consisting of reinforcing agents and additives. Additives include, but are not limited to, tougheners, plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants (both halogen-free and halogen containing flame retardants), nucleating agents, acid scavengers, antioxidants, surface adhesion enhancers, silane coupling agents, and other processing aids.

In some embodiments, the polyamide (PA) concentration in the polymer composition (PC) is at least 20 wt. %, at least 30 wt. %, or at least 40 wt. %. In some embodiments, the polyamide (PA) concentration in the polymer composition (PC) is no more than 85%, no more than 80 wt. % or no more than 70 wt. %. In some embodiments, the polyamide (PA) concentration in the polymer composition (PC) is from 20 wt. % to 85 wt. %, from 30 wt. % to 80 wt. % or from 40 wt. % to 70 wt. %. As used herein, wt. % is relative to the total weight of the polymer composition, unless explicitly noted otherwise.

The polymer composition also includes a carbon fiber. In some embodiments, the carbon fiber is a polyacrylonitrile (“PAN”) based carbon fiber or a pitch (a viscoelastic material composed of aromatic hydrocarbons) based carbon fiber. Excellent results were obtain with PAN based carbon fibers, as demonstrated in the Examples. In some embodiments, the carbon fiber is a standard modulus carbon fiber or an intermediate modulus carbon fiber. Standard modulus carbon fibers have a tensile modulus of from 227 GPa to 235 GPa. Intermediate modulus carbon fibers have a tensile modulus of from 282 GPA to 289 GPa. The carbon fiber can be a virgin carbon fiber or a recycled (post-consumer or post-industrial) carbon fiber (pyrolyzed or over-sized). In some embodiments, the carbon fiber has an average length of at least 1 mm, at least 3 mm, at least 4 mm, at least 5 mm or at least 6 mm. In some embodiments, the glass fiber has an average length of no more than 10 mm. In some embodiments, the carbon fiber has an average length of from 1 mm to 10 mm, from 3 mm to 10 mm, from 4 mm to 10 mm, from 5 mm to 10 mm or more 6 mm to 10 mm.

In some embodiments, the carbon fiber concentration in the polymer composition (PC) is at least at least 10 wt. %, at least 15 wt. % or at least 20 wt. %. In some embodiments, the carbon fiber concentration in the polymer composition (PC) is no more 70 wt. %, no more than 60 wt. % or no more than 50 wt. %. In some embodiments, the carbon fiber concentration in the polymer composition (PC) is from 10 wt. % to 70 wt. %, from 15 wt. % to 70 wt. % from 20 wt. % to 70 wt. %, from 10 wt. % to 60 wt. %, from 15 wt. % to 60 wt. %, from 20 wt. % to 60 wt. %, from 10 wt. % to 50 wt. %, from 15 wt. % to 50 wt. % or from or from 20 wt. % to 50 wt. %.

In some embodiments, the polymer composition (PC) includes a reinforcing agent, in addition to the carbon fiber. A large selection of reinforcing agents, also called reinforcing fibers or fillers, may be added to the polymer composition (PC). In some embodiments, the reinforcing agent is selected from mineral fillers (including, but not limited to, talc, mica, kaolin, calcium carbonate, calcium silicate, magnesium carbonate), glass fibers, additional carbon fibers, synthetic polymeric fibers, aramid fibers, aluminum fibers, titanium fibers, magnesium fibers, boron carbide fibers, rock wool fibers, steel fibers and wollastonite.

In general, reinforcing agents are fibrous reinforcing agents or particulate reinforcing agents. A fibrous reinforcing agent refers to a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the fibrous reinforcing agent (e.g. glass fibers or carbon fibers) has an average length of from 3 mm to 50 mm. In some such embodiments, the fibrous reinforcing agent has an average length of from 3 mm to 10 mm, from 3 mm to 8 mm, from 3 mm to 6 mm, or from 3 mm to 5 mm. In alternative embodiments, fibrous reinforcing agent has an average length of from 10 mm to 50 mm, from 10 mm to 45 mm, from 10 mm to 35 mm, from 10 mm to 30 mm, from 10 mm to 25 mm or from 15 mm to 25 mm. The average length of the fibrous reinforcing agent can be taken as the average length of the fibrous reinforcing agent prior to incorporation into the polymer composition (PC) or can be taken as the average length of the fibrous reinforcing agent in the polymer composition (PC).

With respect to glass fibers, they are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. The glass fibers can be added as endless fibers or as chopped glass fibers. The glass fibers have generally an equivalent diameter of 5 to 20 preferably of 5 to 15 μm and more preferably of 5 to 10 μm. All glass fiber types, such as A, C, D, E, M, S, R, T glass fibers (as described in chapter 5.2.3, pages 43-48 of Additives for Plastics Handbook, 2nd ed, John Murphy), or any mixtures thereof or mixtures thereof may be used.

E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62-75 wt. % of SiO2, from 16-28 wt. % of Al2O3and from 5-14 wt. % of MgO. On the other hand, R, S and T glass fibers comprise less than 10 wt. % of CaO.

In some embodiments, the glass fiber is a high modulus glass fiber. High modulus glass fibers have an elastic modulus of at least 76, preferably at least 78, more preferably at least 80, and most preferably at least 82 GPa as measured according to ASTM D2343. Examples of high modulus glass fibers include, but are not limited to, S, R, and T glass fibers. A commercially available source of high modulus glass fibers is S-1 and S-2 glass fibers from Taishan and AGY, respectively.

The morphology of the glass fiber is not particularly limited. As noted above, the glass fiber can have a circular cross-section (“round glass fiber”) or a non-circular cross-section (“flat glass fiber”). Examples of suitable flat glass fibers include, but are not limited to, glass fibers having oval, elliptical and rectangular cross sections. In some embodiments in which the polymer composition includes a flat glass fiber, the flat glass fiber has a cross-sectional longest diameter of at least 15 μm, preferably at least 20 μm, more preferably at least 22 μm, still more preferably at least 25 μm. Additionally or alternatively, in some embodiments, the flat glass fiber has a cross-sectional longest diameter of at most 40 μm, preferably at most 35 μm, more preferably at most 32 μm, still more preferably at most 30 μm. In some embodiments, the flat glass fiber has a cross-sectional diameter was in the range of 15 to 35 μm, preferably of 20 to 30 μm and more preferably of 25 to 29 μm. In some embodiments, the flat glass fiber has a cross-sectional shortest diameter of at least 4 μm, preferably at least 5 μm, more preferably at least 6 μm, still more preferably at least 7 μm. Additionally or alternatively, in some embodiments, the flat glass fiber has a cross-sectional shortest diameter of at most 25 μm, preferably at most 20 μm, more preferably at most 17 μm, still more preferably at most 15 μm. In some embodiments, the flat glass fiber has a cross-sectional shortest diameter was in the range of 5 to 20 preferably of 5 to 15 μm and more preferably of 7 to 11 μm.

In some embodiments, the flat glass fiber has an aspect ratio of at least 2, preferably at least 2.2, more preferably at least 2.4, still more preferably at least 3. The aspect ratio is defined as a ratio of the longest diameter in the cross-section of the glass fiber to the shortest diameter in the same cross-section. Additionally or alternatively, in some embodiments, the flat glass fiber has an aspect ratio of at most 8, preferably at most 6, more preferably of at most 4. In some embodiments, the flat glass fiber has an aspect ratio of from 2 to 6, and preferably, from 2.2 to 4. In some embodiments, in which the glass fiber is a round glass fiber, the glass fiber has an aspect ratio of less than 2, preferably less than 1.5, more preferably less than 1.2, even more preferably less than 1.1, most preferably, less than 1.05. Of course, the person of ordinary skill in the art will understand that regardless of the morphology of the glass fiber (e.g. round or flat), the aspect ratio cannot, by definition, be less than 1.

In some embodiments, the reinforcing agent (e.g. glass or carbon fibers) concentration in the polymer composition (PC) is at least at least 10 wt. %, at least 15 wt. % or at least 20 wt. %. In some embodiments, the reinforcing agent concentration in the polymer composition (PC) is no more 70 wt. %, no more than 60 wt. % or no more than 50 wt. %. In some embodiments, the reinforcing agent concentration in the polymer composition (PC) is from 10 wt. % to 70 wt. %, from 15 wt. % to 70 wt. % from 20 wt. % to 70 wt. %, from 10 wt. % to 60 wt. %, from 15 wt. % to 60 wt. %, from 20 wt. % to 60 wt. %, from 10 wt. % to 50 wt. %, from 15 wt. % to 50 wt. % or from or from 20 wt. % to 50 wt. %. In some embodiments in which the polymer composition (PC) includes carbon fiber and glass fiber, the total concentration of carbon fiber and glass fiber is within the aforementioned ranges. In alternative such embodiments, the carbon fiber concentration and glass fiber concentration are each, independently within the ranges above.

In some embodiments in which the polymer composition (PC) includes carbon fiber and glass fiber, the weight ratio of the carbon fiber to glass fiber (weight of carbon fiber in the polymer composition (PC)/weight of glass fiber in the polymer composition (PC)) is at least 0.05, at least 0.15, at least 0.2, at least 0.5, at least 0.75, or at least 1. In some embodiments in which the polymer composition (PC) includes carbon fiber and glass fiber, the weight ratio of the carbon fiber to the glass fiber is no more than 4, no more than 3, no more than 2 or no more than 1. In some embodiments, in which the polymer composition (PC) includes carbon fiber and glass fiber, the weight ratio of the carbon fiber to the glass fiber is from 0.05 to 4, from 0.05 to 3, from 0.05 to 2, from 0.05 to 1, from 0.15 to 4, from 0.15 to 3, from 0.15 to 2, from 0.15 to 1, from 0.2 to 5, from 0.2 to 4, from 0.2 to 3, from 0.2 to 1, from 0.5 to 4, from 0.5 to 3, from 0.5 to 2 from 0.5 to 1, from 1 to 4, from 1 to 3 or from 1 to 2.

In some embodiments, the polymer composition (PC) includes a toughener. A toughener is generally a low Tg polymer, with a Tg for example below room temperature, below 0° C. or even below −25° C. As a result of its low Tg, the tougheners are typically elastomeric at room temperature. Tougheners can be functionalized polymer backbones.

The polymer backbone of the toughener can be selected from elastomeric backbones comprising polyethylenes and copolymers thereof, e.g. ethylene-butene; ethylene-octene; polypropylenes and copolymers thereof, polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

In some embodiments, the toughener concentration in the polymer composition (PC) is at least 1 wt. %, at least 2 wt. % or at least 3 wt. %. In some embodiments, the toughener concentration in the polymer composition (PC) is no more than 20 wt. %, no more than 15 wt. % or no more than 10 wt. %. In some embodiments, the toughener concentration is the polymer composition (PC) is from 1 wt. % to 20 wt. %, from 2 wt. % to 15 wt. % or from 3 wt. to 10 wt. %.

As noted above, the polymer compositions (PC) are desirably incorporated into electrical and electronic articles that are exposed to elevated temperatures in their intended use environment (e.g. in, or in close proximity to, engine bays). Accordingly, in some embodiments, a flame retardant is desirably incorporated into the polymer compositions (PC), in case of overvoltage or other combustion source (e.g. in automotive or aerospace engine bay application settings). Still further, for analogous reasons, the flame retardant is preferably a halogen-free flame retardant.

In some embodiments, the halogen-free flame retardant is an organophosphorous compound selected from the group consisting of phosphinic salts (phosphinates), diphosphinic salts (diphosphinates) and condensation products thereof. Preferably, the organophosphorous compound is selected from the group consisting of phosphinic salt (phosphinate) of the formula (I), a diphosphinic salt (diphosphinate) of the formula (II) and condensation products thereof:

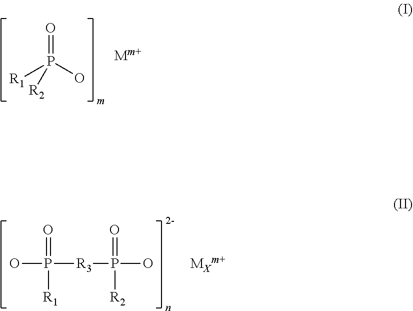

wherein, R₁, R₂ are identical or different and each of R₁ and R₂ is a hydrogen or a linear or branched C₁-C₆ alkyl group or an aryl group; R₃ is a linear or branched C₁-C₁₀ alkylene group, a C₆-C₁₀ arylene group, an alkyl-arylene group, or an aryl-alkylene group; M is selected from calcium ions, magnesium ions, aluminum ions, zinc ions, titanium ions, and combinations thereof; m is an integer of 2 or 3; n is an integer of 1 or 3; and x is an integer of 1 or 2.

Preferably, R₁ and R₂ are independently selected from methyl, ethyl, n-propyl, isopropyl, n-butyl, tert-butyl, n-pentyl, and phenyl; R3 is selected from methylene, ethylene, n-propylene, isopropylene, n-butylene, tert-butylene, n pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene, and phenylbutylene; and M is selected from aluminum and zinc ions.

Phosphinates are preferred as organophosphorous compound. Suitable phosphinates have been described in U.S. Pat. No. 6,365,071, incorporated herein by reference. Particularly preferred phosphinates are aluminum phosphinates, calcium phosphinates, and zinc phosphinates. Excellent results were obtained with aluminum phosphinates. Among aluminum phosphinates, aluminium ethylmethylphosphinate and aluminium diethylphosphinate and combinations thereof are preferred. Excellent results were in particular obtained when aluminium diethylphosphinate was used.

In some embodiments, the halogen-free flame retardant concentration in the polymer composition (PC) is at least 5 wt. % or at least 7 wt. %. In some embodiments, the halogen-free flame retardant concentration in the polymer composition (PC) is no more than 20 wt. % or no more than 15 wt. %. In some embodiments, the halogen-free flame retardant concentration in the polymer composition (PC) is from 5 wt. % to 20 wt. %, from 7 wt. % to 20 wt. %, from 5 wt. % to 15 wt. % or from 7 wt. % to 15 wt. %.

In some embodiments, the polymer composition (PC) further includes an acid scavenger, most desirably in embodiments incorporating a halogen free flame retardant. Acid scavengers include, but are not limited to, silicone; silica; boehmite; metal oxides such as aluminum oxide, calcium oxide iron oxide, titanium oxide, manganese oxide, magnesium oxide, zirconium oxide, zinc oxide, molybdenum oxide, cobalt oxide, bismuth oxide, chromium oxide, tin oxide, antimony oxide, nickel oxide, copper oxide and tungsten oxide; metal powder such as aluminum, iron, titanium, manganese, zinc, molybdenum, cobalt, bismuth, chromium, tin, antimony, nickel, copper and tungsten; and metal salts such as barium metaborate, zinc carbonate, magnesium carbonate, calcium carbonate, and barium carbonate. In some embodiments, in which the polymer composition (PC) includes an acid scavenger, the acid scavenger concentration is from 0.01 wt. % to 5 wt. %, from 0.05 wt. % to 4 wt. %, from 0.08 wt. % to 3 wt. %, from 0.1 wt. % to 2 wt. %, from 0.1 wt. % to 1 wt. %, from 0.1 wt. % to 0.5 wt. % or from 0.1 wt. % to 0.3 wt. %.

In some embodiments, the total additive concentration in the polymer composition (PC) is at least 0.1 wt. %, at least 0.2 wt. % or at least 0.3 wt. %. In some embodiments, the total additive concentration in the polymer composition (PC) is no more than 20 wt. %, no more than 15 wt. %., no more than 10 wt. %, no more than 7 wt. % or no more than 5 wt. %. In some embodiments, the total additive concentration in the polymer composition (PC) is from 0.1 wt. % to 20 wt. %, from 0.1 wt. % to 15 wt. %, from 0.1 wt. % to 10 wt. %, from 0.2 wt. % to 7 wt. % or from 0.3 wt. to 5 wt. %.

In some embodiments, the polymer composition (PC) further includes one or more additional polymers. In some such embodiments, at least one of the additional polymers is a semi-crystalline or amorphous polyamides, such as aliphatic polyamides, semi-aromatic polyamides, and more generally a polyamide obtained by polycondensation between an aromatic or aliphatic saturated diacid and an aliphatic saturated or aromatic primary diamine, a lactam, an amino-acid or a mixture of these different monomers.

### Preparation of the Polymer Composition (PC)

The invention further pertains to a method of making the polymer composition (PC). The method involves melt-blending the polyamide (PA) and one or more optional components (reinforcing agents and additives).

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, long fibers as well as continuous fibers), drawing extrusion or pultrusion may be used to prepare a reinforced composition.

### Articles and Applications

The present invention also relates to articles comprising the polymer composition (PC). At least in part due to the improved mechanical performance at elevated temperatures and improved mechanical retention after heat aging, the polymer compositions (PC) are desirably incorporated into any article that is exposed to elevated temperatures and aqueous polyol solutions during their intended use (e.g. exposed to temperatures of 125° C., 140° C. or 150° C. for at least 30 minutes, 1 hour or 10 hours).

In some embodiments, the article is selected from the group consisting of automotive components (including motorcycle components, all-terrain vehicle components and marine components) and aerospace components (including airplane components, helicopter components, unmanned aerial aircraft components, missile components, rocket components and satellite components). Examples of automotive components include, but are not limited to, components in thermal management systems (including, but not limited to, thermostat housings, water inlet/outlet valves, water pumps, water pump impellers, and heater cores and end caps), air management system components (including, but not limited to, turbocharger actuators, turbocharger by-pass valves, turbocharger hoses, EGR valves, CAC housings, exhaust gas recirculation systems, electronic controlled throttle valves, and hot air ducts), transmission components and launch device components (including, but not limited to, dual clutch transmissions, automated manual transmissions, continuously variable transmissions, automatic transmissions, torque convertors, dual mass flywheels, power takeoffs, clutch cylinders, seal rings, thrust washers, thrust bearings, needle bearings, and check balls), automotive electronic components, automotive lighting components (including, but not limited to, motor end caps, sensors, ECU housings, bobbins and solenoids, connectors, circuit protection/relays, actuator housings, Li-Ion battery systems, and fuse boxes), traction motor and power electronic components (including, but not limited to, battery packs), fuel and selective catalytic reduction (“SCR”) systems (including, but not limited to, SCR module housings and connectors, SCR module housings and connectors, fuel flanges, rollover valves, quick connects, filter housings, fuel rails, fuel delivery modules, fuel hoses, fuel pumps, fuel injector o-rings, and fuel hoses), fluid system components (e.g. fuels system components) (including, but not limited to inlet and outlet valves and fluid pump components), interior components (e.g. dashboard components, display components, and seating components), and structural and lightweighting components (e.g. gears and bearings, sunroofs, brackets and mounts, electrical battery housings, thermal management components, braking system elements, and pump and EGR systems). The polymer compositions are further desirably incorporated in the aforementioned articles where they are exposed to elevated temperatures (e.g. within the engine bay).

In some embodiments, the article is molded from the polymer composition (PC) by any process adapted to thermoplastics, e.g. extrusion, injection molding, blow molding, rotomolding or compression molding. The polymer composition (C) may also be used in overmolding pre-formed shapes to build hybrid structures.

In some embodiments, the article is printed from the polymer composition (PC) by a process including a step of extruding the polymer composition (PC), which is for example in the form of a filament, or including a step of laser sintering the polymer composition (PC), which is in this case in the form of a powder.

The present invention also relates to a method for manufacturing a three-dimensional (3D) object with an additive manufacturing system, including: providing a part material including the polymer composition (PC), and printing layers of the three-dimensional object from the part material.

The polymer composition (PC) can therefore be in the form of a thread or a filament to be used in a process of 3D printing, e.g. Fused Filament Fabrication, also known as Fused Deposition Modelling (“FDM”).

The polymer composition (PC) can also be in the form of a powder, for example a substantially spherical powder, to be used in a process of 3D printing, e.g. Selective Laser Sintering (“SLS”).

### Use of the Polymer Compositions (PC) and Articles

The present invention relates to the use of the polymer composition (PC) or articles for manufacturing an automotive component or an aerospace component, as described above. The present invention also relates to the use of the polymer composition (PC) for 3D printing an object.

### EXAMPLES

The present examples demonstrate the synthesis, thermal performance, and mechanical performance of the polyamides.

The raw materials used to form the samples as provided below:
Polyamide 1 (“PA1”): PA 6,T/1,3-BAC,T/6,CHDA/1,3-BAC,CHDA (Tg=165° C. and Tm=330° C.)), synthesized from
   Hexamethylenediamine (70 wt %, from Ascend Performance Materials)
   1,3-bis(aminomethyl)cyclohexane (from Mitsubishi Gas Chemical Company)
   Terephthalic Acid (from Flint Hills Resources)
   1,4-Cyclohexanedicarboxylic Acid (from Eastman Chemical Company)
Polyamide 2 (“PA2”): PA 6T/6I (70/30) (from Solvay Specialty Polymers)
Polyamide 3 (“PA3”): PA 6T/6I (70/30) (from Solvay Specialty Polymers)
Polyamide 4 (“PA4”): PA 6T/66 (65/35) (from Solvay Specialty Polymers
Polyamide 5 (“PA5”): PA 6T/66 (65/35) (from Solvay Specialty Polymers)
Polyamide 6 (“PA6”): PA 6T/66 (55/45) (from Solvay Specialty Polymers)
Polyamide 7 (“PA7”): PA 6T/6I/66 (65/25/10) (from Solvay Specialty Polymers
Toughener: maleic anhydride grafted SEBS copolymer (KRATON™ FG 1901 GT, from Kraton Corporation)
Heat Stabilizer 1 (“HS1”): CuI/KI/Magnesium stearate (HS Triblend, from Ajay North America)
Heat Stabilizer 2 (“HS2”): 4-(1-methy-1-phenylethyl)N-[4-(1-methyl-1-phenylethyl)phenyl] aniline (NAUGARD® 445, from Addivant)
Additive Package 1: Additive package containing a heat stabilizer, lubricant and pigment
Additive Package 2: Additive package containing an antioxidant, heat stabilizer, lubricant and pigment
Nucleating Agent: Talc (Mistron Vapor, from Imerys)
Reinforcing Agent 1 (“CF”): Carbon Fiber (CF.OS.U1-6 mm, from Apply Carbon S.A./Procotex S.A. Corporation)
Reinforcing Agent 2 (“GF”): E Glass Fiber (ChopVantage® HP 3610, from Nippon Electric Glass)

### Example 1—Synthesis of PA1

This example demonstrates the synthesis of Polyamide 1.

PA 1 was prepared in an autoclave reactor equipped with a distillate line fitted with a pressure control valve. The reactor was charged with 498 g of 70% hexamethylenediamine, 165 g of 1,3-bis(aminomethyl)cyclohexane, 635 g of terephthalic acid, 20 g of 1,4-cyclohexanedicarboxylic acid, 355 g of deionized water, 7.2 g of glacial acetic acid and 0.32 g of phosphorus acid. The reactor was sealed, purged with nitrogen and heated to 260° C. The steam generated was slowly released to keep the internal pressure at 120 psig. The temperature was increased to 3350° C. The reaction mixture was kept at 335° C. for 60 minutes while the reactor pressure was reduced to atmospheric. The polymer was discharged from the reactor and used in the preparation of the compound formulations.

### Example 2—Mechanical Performance of Carbon Fiber Filled Systems

This example demonstrates the mechanical performance of polymer compositions including carbon fibers.

To demonstrate mechanical performance, polymer compositions were formed by melt blending the polymer resins (either PPA1, PPA2 or PPA3) with various components in an extruder. The polymer compositions were then molded into test samples. Tensile modulus and tensile strength were measured according to ISO 527-2 on dumbbell-shaped, ISO type 1A tensile specimens with the following nominal dimensions: full length of 170 mm, gauge length of 75 mm, parallel section length of 80 mm, parallel section width of 10 mm, grip section width of 20 mm, and thickness of 4 mm. Tensile modulus and tensile strength were measured at a testing temperature of 23° C. to 150° C. Tables 1 and 2 display sample parameters and tensile properties, respectively. In the Tables, “E” refers to an example and “CE” refers to a counter example. All values in Table 1 (and Table 3) are reported in wt. %

TABLE 1

| Component | E1 | CE1 | CE2 | CE3 | CE4 |
|---|---|---|---|---|---|
| PA1 | 57.80 | | | | |
| PA2 | | 57.80 | | | |
| PA4 | | | 58.30 | | |
| PA6 | | | | 58.30 | |
| PA7 | | | | | 58.30 |
| Additive | 1.70 | 1.70 | 1.70 | 1.70 | 1.70 |
| Package | | | | | |
| Nucleating | 0.50 | 0.50 | 0 | 0 | 0 |
| Agent | | | | | |
| CF | 40 | 40 | 40 | 40 | 40 |

TABLE 2

| Tensile | Temperature | | | | | |
|---|---|---|---|---|---|---|
| Property | (° C.) | E1 | CE1 | CE2 | CE3 | CE4 |
| Modulus | 23 | 35.6 | 37.8 | 36.9 | 35.6 | 37.7 |
| (GPa) | 125 | 28.20 | 19.40 | 15.09 | 13.05 | 13.14 |
| | 140 | 22.66 | | | | |
| | 150 | 18.00 | 10.01 | 13.02 | 11.77 | 9.54 |
| Strength | 23 | 277 | 321 | 298 | 309 | 329 |
| (MPa) | 125 | 182.5 | 165.5 | 157.2 | 139.4 | 140.80 |
| | 140 | 161.00 | | | | |
| | 150 | 134.5 | 101.0 | 129.2 | 119.7 | 98.8 |

Referring to Table 2, the sample formed from PA1 unexpectedly had significantly improved tensile modulus and strength at elevated temperatures, relative to the samples formed from PA2, PA4, PA6 and PA7. For example, with respect to tensile modulus, E1 was significantly more rigid (higher tensile modulus) at 125° C., 140° C. and 150° C., relative to that of CE1 to CE4. Similar results were obtained for the tensile strength. Notably, comparison of E1 with CE2 to CE4 demonstrates improved tensile modulus and strength at elevated temperatures with incorporation of the cycloaliphatic diamine bis(aminoalkyl)cyclohexane and the cycloaliphatic dicarboxylic acid cyclohexanedicarboxylic acid, relative to incorporation of the linear aliphatic dicarboxylic acid, adipic acid. Comparison of CE1 with CE2 demonstrates similar improvements, relative to incorporation of the aromatic dicarboxylic acid isophthalic acid. The results displayed in Table 2 are particularly surprising as, at room temperature (23° C.), the tensile modulus and strength of E1 is the same as or lower than those of CE1 to CE4. The results demonstrate that E1 has superior mechanical performance at elevated temperatures and are well suited for structural articles that are exposed to elevated temperatures in their intended application settings (e.g. in engine bays).

Mechanical performance retention was also demonstrated. To demonstrate mechanical performance retention, the test samples were heat aged by placing them in an oven (air atmosphere) and heating them at 200° C. for 500 hours. Tensile strength was measured as described above, though at room temperature (23° C.), before (“as molded”) and after heat aging. Table 3 displays the results of heat aging testing.

TABLE 3

| Tensile Property | | E1 | CE1 | CE2 | CE3 | CE4 |
|---|---|---|---|---|---|---|
| Strength | After Heat | 227 | 221 | 98.1 | 85.5 | 249 |
| | Aging | | | | | |
| | (MPa) | | | | | |
| | Retention | 82.0 | 68.8 | 32.9 | 27.7 | 75.7 |
| | (%) | | | | | |

Referring to Table 3, the samples formed from PA1 surprisingly had improved tensile strength after heat aging, as well as tensile strength retention, relative to the samples formed from PA2, PA4, PA6 and PA7. Again, as noted above with respected to mechanical performance at elevated temperatures, comparison of E1 with CE2 to CE4 demonstrates improved tensile modulus and strength with incorporation of the cycloaliphatic diamine bis(aminoalkyl)cyclohexane or cycloaliphatic dicarboxylic acid cyclohexanedicarboxylic acid, relative to incorporation of the linear aliphatic dicarboxylic acid adipic acid. Comparison of CE1 with CE2 demonstrates similar improvements, relative to incorporation of the aromatic dicarboxylic acid isophthalic acid.

### Example 3—Mechanical Performance of Carbon Fiber and Glass Fiber Filled Systems

This example demonstrates the mechanical performance of polymer compositions including a combination of carbon fiber and glass fiber.

To demonstrate mechanical performance, polymer compositions were formed by melt blending the polymer resins (either PA1, PA3, PA5, PA6, or PA7) with various components in an extruder. The polymer compositions were then molded into test samples. Tensile modulus and tensile strength were measured as described above at a testing bar temperature of 23° C. to 150° C. Tables 4 and 5 display sample parameters and tensile properties, respectively. Values in Table 4 are reported in wt. %.

TABLE 4

| Component | E2 | CE5 | CE6 | CE7 | CE8 |
|---|---|---|---|---|---|
| PA1 | 40.15 | | | | |
| PA3 | | 40.15 | | | |
| PA5 | | | 40.65 | | |
| PA6 | | | | 40.65 | |
| PA7 | | | | | 40.65 |
| Toughener | 2.80 | 2.80 | 2.80 | 2.80 | 2.80 |
| Additive | 1.55 | 1.55 | 1.55 | 1.55 | 1.55 |
| Package 2 | | | | | |
| Nucleating | 0.50 | 0.50 | 0 | 0 | 0 |
| Agent | | | | | |
| CF | 10 | 10 | 10 | 10 | 10 |
| GF | 45 | 45 | 45 | 45 | 45 |

TABLE 5

| Tensile | Temperature | | | | | |
|---|---|---|---|---|---|---|
| Property | (° C.) | E2 | CE5 | CE6 | CE7 | CE8 |
| Modulus | 23 | 24.7 | 26.6 | 25.1 | 25.4 | 25.8 |
| (GPa) | 125 | 20.56 | 14.22 | 10.92 | 10.23 | 9.96 |
| | 140 | 16.80 | | | | |
| | 150 | 13.10 | 7.60 | 9.67 | 9.06 | 7.09 |
| Strength | 23 | 249 | 272 | 245 | 252 | 271 |
| (MPa) | 125 | 143.6 | 127.4 | 117.0 | 112.4 | 105.40 |
| | 140 | 123.40 | | | | |
| | 150 | 103.5 | 75.3 | 98.1 | 95.6 | 77.8 |

Referring to Table 5, the sample formed from PA1 unexpectedly had significantly improved tensile modulus and strength at elevated temperatures, relative to the samples formed from PA3, PA5, PA6 and PA7. For example, with respect to tensile modulus, E2 was significantly more rigid (higher tensile modulus) at 125° C., 140° C. and 150° C., relative to that of CE6 to CE8. Similar results were obtained for the tensile strength. Notably, comparison of E2 with CE6 to CE8 demonstrates improved tensile modulus and strength with incorporation of the cycloaliphatic diamine bis(aminoalkyl)cyclohexane or cycloaliphatic dicarboxylic acid cyclohexanedicarboxylic acid, relative to incorporation of the linear aliphatic dicarboxylic acid adipic acid. Comparison of E2 with CE5 demonstrates similar results, relative to incorporation of the aromatic dicarboxylic acid isophthalic acid. The results displayed in Table 5 are particularly surprising, as at room temperature (23° C.) the tensile modulus and strength of E2 slightly higher or lower than those of CE5 to CE8. The results demonstrates that E2 has superior mechanical performance at elevated temperatures and are well suited for structural articles that are exposed to elevated temperatures in their intended application settings (e.g. in engine bays).

The embodiments above are intended to be illustrative and not limiting. Additional embodiments are within the inventive concepts. In addition, although the present invention is described with reference to particular embodiments, those skilled in the art will recognized that changes can be made in form and detail without departing from the spirit and scope of the invention. Any incorporation by reference of documents above is limited such that no subject matter is incorporated that is contrary to the explicit disclosure herein.

1. A polymer composition (PC) comprising:
a polyamide (PA) and
a carbon fiber;
wherein
the polyamide (PA) is derived from the polycondensation of monomers in a reaction mixture comprising:
a diamine component (A) comprising:
20 mol % to 95 mol % of a C₄ to C₁₂ aliphatic diamine and
5 mol % to 80 mol % of bis(aminoalkyl)cyclohexane,
wherein mol % is relative to the total moles of each diamine in the diamine component;
a dicarboxylic acid component (B) comprising:
30 mol % to 100 mol % of terephthalic acid and
0 mol % to 70 mol % of a cyclohexanedicarboxylic acid,
wherein mol % is relative to the total moles of each dicarboxylic acid in the dicarboxylic acid component.

2. The polymer composition (PC) of claim 1, wherein the C₄ to C₁₂ aliphatic diamine is selected from the group consisting of is selected from the group consisting of 1,4-diaminobutane, 1,5-diaminopentane, 2-methyl-1,5-diaminopentane, 1,6-diaminohexane, 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12-diaminododecane, and combinations thereof.

3. The polymer composition (PC) of claim 1, wherein the bis(aminoalkyl)cyclohexane is 1,3-bis(aminomethyl)cyclohexane or 1,4-bis(aminomethyl)cyclohexane.

4. The polymer composition (PC) of claim 1, wherein the dicarboxylic acid component (B) comprises 1 mol % to 70 mol % of cyclohexanedicarboxylic acid relative to the total moles of each dicarboxylic acid in the dicarboxylic acid component.

5. The polymer composition (PC) of claim 1, wherein the bis(aminoalkyl)cyclohexane is 1,3-bis(aminomethyl)cyclohexane and the cyclohexane dicarboxylic acid is 1,4-cyclohexanedicarboxylic acid.

6. The polymer composition of claim 1, wherein the polyamide (PA) concentration is from 20 wt. % to 85 wt. %, based on the total weight of the polymer composition (PC).

7. The polymer composition (PC) of claim 1, wherein the carbon fiber concentration is from 10 wt. % to 70 wt. %, based on the total weight of the polymer composition.

8. The polymer composition (PC) of claim 1, comprising glass fiber.

9. The polymer composition (PC) of claim 8, wherein the glass fiber concentration is from 10 wt. % to 70 wt. %.

10. The polymer composition (PC) of claim 8, wherein the weight ratio of the carbon fiber to the glass fiber is from 0.05 to 4.

11. The polymer composition (PC) of claim 1, comprising a tensile modulus at 125° C. of at least 20 GPa and a tensile modulus at 150° C. of at least 12 GPa.

12. The polymer composition (PC) of claim 1, comprising a tensile strength at 125° C. of at least 140 MPa and a tensile modulus at 150° C. of at least 100 MPa.

13. The polymer composition (PC) of claim 1, comprising a tensile strength retention of at least 80%.

14. The polymer composition (PC) of claim 1, comprising a tensile strength after heat aging of at least 80%, wherein heat aging comprises heating the polymer composition (PC) at 200° C. for 500 hours.

15. An article comprising the polymer composition (PC) of claim 1, wherein the article is an automotive component or an aerospace component.
